(19) United States
(12) Patent Application Publication
(10) Pub. No.: US 2003/0142796 A1
(43) Pub. Date: Jul. 31, 2003

(54) Tone adapter for the control of model railroads

(76) Inventor: Stanley R. Ames JR., Chelmsford, MA (US)

Correspondence Address: STANLEY R. AMES, JR., 8 HIGATE ROAD, CHELMSFORD, MA, 01824, US

(21) Appl. No.: 10/055,761

(22) Filed: Jan. 25, 2002

(51) Int. Cl. H04M 1/64

(52) U.S. Cl. 379/88.04

(57) ABSTRACT

New techniques are presented for integrating wireless control methods into control systems for the control, automation and operation of model railroads. The invention allows for utilization of standard devices developed for the telecommunications industry to be applied for the purpose of model railroad control.

### BACKGROUND OF INVENTION

A long-standing problem for model railroad control is achieving a wireless interface for the control of model railroad objects such as the control of the speed direction and functions of model railroad locomotives or the control of the routes that the model train will take. Past approaches have included incorporating wireless technology into the model railroad handheld.

This has posed several problems. Amongst them are interference from other wireless controls, the difficulty of developing product that can be used internationally because of frequency differences, and the price that must be charged because of the relatively small market.

In light of these problems another method had to be invented to allow a wide choice of cordless options for model railroad control.

### SUMMARY OF INVENTION

There are twelve DTMF tones that have become standardized in telecommunications equipment. These tones are used by every telecommunication that uses tones rather than pulses in use today worldwide. This invention provides a method for utilizing standard phone tone bursts to form the basis for a wireless interface.

While using tone bursts to provide information from the end user to a model railroad control system solves the communication flow in one direction, tone bursts do not help in the flow of information in the other direction. Many telecommunication devices incorporate a technique called call-waiting caller ID (also called off-hook communication). This allows the station to send information to the subscriber device. This invention provides a method for using off-hook communication in a model railroad application to send information from the model railroad control system back to the user input device for the purpose of displaying relevant information about the status of the train being controlled or about other information relevant to the status of the train being controlled or the railroad.

Visual information is only one form of two way communication. The voice circuits contained in telecommunications equipment allows for verbal information to be sent to the operator or voice commands to be send from the operator to the control system.

The utilization of standard telephone communications techniques allows the utilization of a wide range of cordless devices to be employed for the new use of controlling a model railroad. This facilitates use worldwide because the tone adapter can be built to follow standard conventions with no additional design or approval required as the cordless phone device being used can be country specific. This allows the utilization of phone based technology for a whole new application, that of controlling a model railroad.

### BRIEF DESCRIPTION OF DRAWINGS

FIG. 1 is a block diagram using a tone generator (phone) interfaced to a tone adapter which is interfaced into a model railroad control system

FIG. 2 is a block diagram using a tone generator (phone) interfaced to a tone adapter which is connected to a model railroad control bus

FIG. 3 is a block diagram using a tone generator (phone) interfaced to a tone adapter which is built as an attached logic module in a distributed model railroad control network

### DETAILED DESCRIPTION

Touch tone phones worldwide generate a pair of tones to represent the various keys. There is a “low tone” and a “high tone” associated with each button (0 through 9, plus * (star) and # (pound symbol). This provides 12 unique DTMF tones sequences. The tone frequencies were designed to ensure highly reliable communications by avoiding harmonics and other problems that could arise when two tones are sent and received. Utilizing the 12 standard tones used by the phone system, an adapter can be constructed which translates a sequence of these standard tones into an information stream which can subsequently be used for the purpose of controlling devices on or attached to a model railroad. This provides for a highly reliable wireless interface for the purpose of controlling a model railroad.

Further, utilizing one of the several standard off-hook caller id protocols, the tone adapter can generate an information stream that can cause any device that implements call waiting called id to display the desired information in a display controlled by a device that can decode the off-hook caller id protocols.

Further utilizing sound and/or voice generation, the tone adapter can generate speech or specific railroad sounds which can be transmitted using phone standards to a remote device for the purpose of informing the end user of key events that are occurring in the operation of the model railroad much in the same way that the radio in a cab of a prototype locomotive informs the engineer about events concerning the operation of the locomotive and train. This allows the operator to experience realistic sounds that would occur in the operation of a real railroad and can be localized to provide a different sound experience for each specific operator.

Finally voice recognition chips in the tone adapter interface can be used to allow for voice control of model railroads which is particularly useful for facilitating operation by handicapped individuals.

There are several methods for attaching/integrating a tone adapter to a model railroad control system

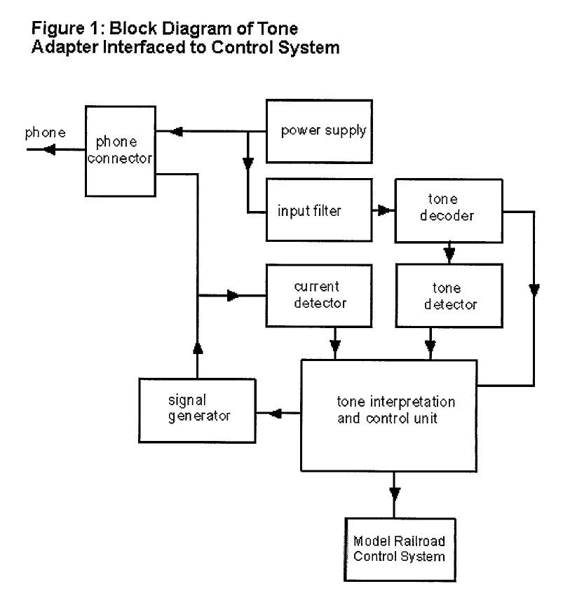

1) The tone adapter can be integrated directly into the model railroad control equipment. The tone adapter is used to directly input commands to the control system by translating sequences of tones and/or to provide information to he end user via means of off-hook caller id or voice. (See FIG. 1)

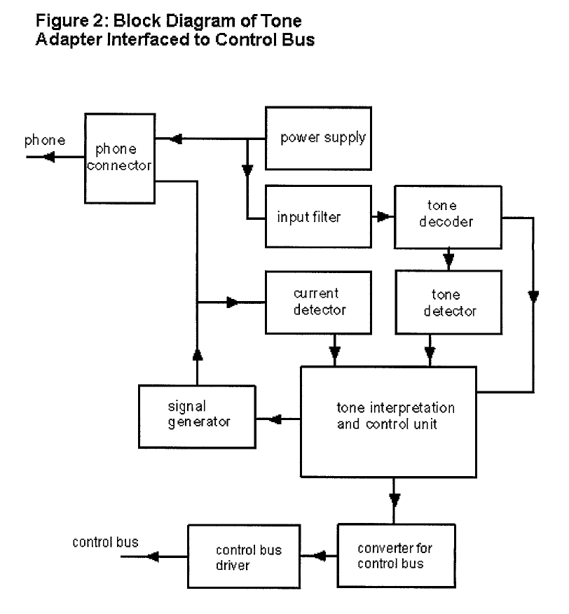

2) The Tone adapter can be connected to a model railroad control bus and provides information to the control unit received by decoding the tones and or provides information received back from the control unit to the end user via means of off-hook caller id or voice. (See FIG. 2)

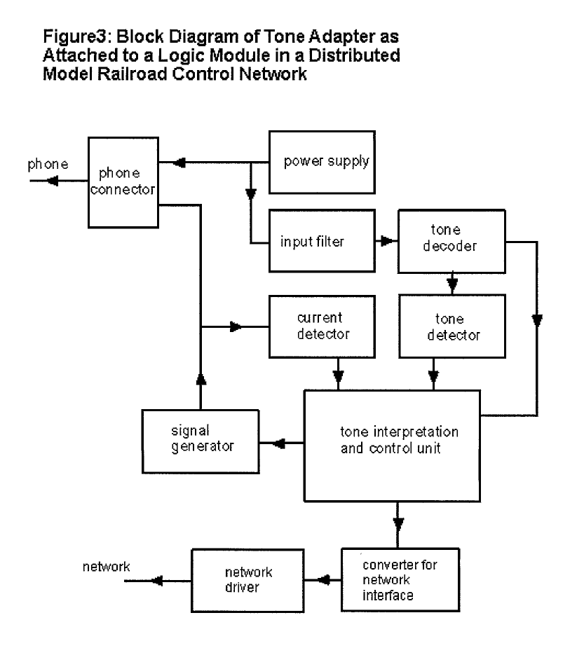

3) The tone adapter can be or attached to an attached logic module in a distributed model railroad control network. The tone adapter contains the logic to issue commands based on the decoded tone pules and/or accept responses or otherwise interact to the distributed control network for the purpose of disseminating instructions received via tones or transmitting integrated information received from the network and transmitting this information back to the end user via means of off-hook caller id or voice. (See FIG. 3)

The invention utilizes a microcontroller to decoder the tones received. A device such as a microcontroller in the tone adapter decodes the tones. A sequence of tones is used to define a specific operation. For example the sequence “#7 * * 3 2 5 3” could be used to inform the system that locomotive 7 should have function 3 turned on and move forward at speed step 1. The use of tone sequences can be very simple from just changing the speed of a locomotive or a sequence of tones can be used to impact various complex model railroad operations. The use of tones for invoking commands also allows for the method of storing a sequence of tones within the phone and using the memory circuits in the phone for invoking commonly used sequences of commands.

Communication back from the tone module to the user device is provided to allow the model railroad system to provide feedback to the operator for the purpose of informing the operator as to the state of operations. Most telecommunications equipment that provide off-hook caller id capability have a two or three line display for the purpose of displaying caller ID using one of the standards for off-hook communications. These standards differ in different markets in the world and include the European Telecommunications Standards Institute's (ETSI) standard (ETS 300 659-1 & -2, and ETS 300 778-1 and -2) allows 3 physical transport layers (Bellcore, BT and CCA) combined with 2 data formats (MDMF & SDMF).

The use of caller ID display provides a method for the display of both alphanumeric and numeric information normally on a three line display. While the intended use for the display is the ID of a caller and time of the call, the model railroad tone adapter can utilize the same circuitry for displaying any information that can be displayed within the same format. For example, if a user is controlling the speed of locomotive 8444, the tone adapter can send “L 8444 S 6 F” to display locomotive identity, current speed and direction on the first line line of the display, the functions that are currently on in the second line and a fast clock (scale time) display of the time in the third line. Other more complicated alphanumeric display sequences can be used to display a wide variety of information relevant to model railroad control. This information can be refreshed each time information changes or at set refresh intervals for a continuous display of current information.

Utilizing tone and caller ID technology is but one method for integrating telephonic technology into model railroad control. The use of phone tones also facilitates the use of the capabilities of the voice circuits as well. Sounds generated by the control system can be fed back to the phone using the audio portions of the phone circuit and through a telephone voice reception information can be conveyed to the operator. Such sounds can include the sounds from operation (such as whistle, bell, and prime mover), to computer generated sounds to inform the user of operation events such as approaching a signal or turnout, or human sounds coming from a dispatcher. Adding the audio component to the tone adapter is one method for increases the illusion of prototypical operation.

Using the microcontroller to generate sounds the tone module can also serve as a intelligent interface providing the operation with information and control much the same as a locomotive engineer would hear in the operation of a prototype locomotive. For example when the train passes a point the number of axles can be counted. This

1) Using DTMF tone bursts for the purpose of interfacing a model railroad input control device to a model railroad control system for the purpose of controlling or configuring some aspect of model railroad control

2) Using off-hook caller id protocols as a means for transmitting information back from a model railroad control system to a display for the purpose of conveying information to the user concerning events happening on or about the model railroad.

3) Utilizing sound generation and/or voice recognition techniques combined with a device intended to be used by a specific operator for the purpose of transmitting information from or to the device for the purpose of controlling a device on or attached to the model railroad or for the purpose of providing information about an event related to model railroad control.

4. [Claim Reference] 1a) A method as defined in claim 1, wherein the tone adapter is integrated into a model railroad control system

5. [Claim Reference] 1b} A method as defined in claim 1, wherein the tone adapter is a device attached to a bus connected to a model railroad system

6. [Claim Reference] 1c) A method as defined in claim 1, wherein the tone adapter is an attached logic module model attached to a model railroad control network

7. [Claim Reference] 2a) A method as defined in claim 2 wherein the information transmitted using the off hook caller id caller id protocols displays some aspect related to the device being controlled such as the speed, direction or function status.

8. [Claim Reference] 2b) A method as defined in claim 2 wherein the information transmitted using off hook caller id protocols displays an event or instruction related to the operation of the control of the model railroad.

9. [Claim Reference] 2c) A method as defined in claim 2 wherein the information displayed is the scaled time as it currently exists on the model railroad being controlled.

10. [Claim Reference] 3a) A method as defined in claim 3 wherein the sound generated is intended to be related to the operation of the device being controlled to include such items as the whistle, bell and or prime mover or exhaust sounds.

11. [Claim Reference] 3b) A method as defined in claim 3 wherein the sound generated is related to the location or related to instructions or information relating to an event being controlled on the model railroad.
